(19) United States
(12) Patent Application Publication
(10) Pub. No.: US 2013/0198370 A1
(43) Pub. Date: Aug. 1, 2013

(54) METHOD FOR VISUALIZING SERVER RELIABILITY, COMPUTER SYSTEM, AND MANAGEMENT SERVER

(71) Applicants: Seiji Aguchi, Bedford, MA (US); Yoshifumi Takamoto, Kokubunji (JP); Noboru Obata, Yokohama (JP)

(72) Inventors: Seiji Aguchi, Bedford, MA (US); Yoshifumi Takamoto, Kokubunji (JP); Noboru Obata, Yokohama (JP)

(73) Assignee: Hitachi, Ltd.

(21) Appl. No.: 13/642,825

(22) PCT Filed: May 14, 2010
(86) PCT No.: PCT/JP2010/058573

§ 371 Date: Jan. 9, 2013

(51) Int. Cl. H04L 12/26

(52) U.S. Cl. CPC H04L 43/04
USPC 709/224

(57) ABSTRACT

The disclosed method quantifies the reliability of hardware and software installed in a physical server, and calculates an indication of the reliability of each of a plurality of physical servers. Configuration information, failure information, and running information of the hardware and software installed in the physical servers are collected while taking into account lifecycle information of the physical servers, and an indicator for the reliability of the hardware and software is quantified and calculated. Furthermore, an indicator of the reliability of a physical server as a whole is determined based on the indicators for the reliability of the hardware and the software.

### BACKGROUND OF THE INVENTION

This invention relates to a method of visualizing reliability of a computer by expressing the reliability as a numerical value.

Virtualization has penetrated corporate systems through its first use for integrating servers and now is increasingly used as infrastructure for supporting an intra-corporate cloud. In operating and managing the intra-corporate cloud, server resource management products for providing flexibility to allocation of server resources are attracting attention.

In the server resource management, a resource allocation status and a free resource status are recognized so that flexibility may be provided to allocation of necessary tasks to appropriate servers and addition of a server to tasks with poor performance. For example, a method of evaluating a free resource status of a memory or a CPU by a star rating function (star counts) has been introduced to the market.

Further, an attempt of taking not only the free resource of the server to be allocated but also a hardware failure history into consideration is disclosed in, for example, Japanese Patent Application Laid-open No. 8-36502. In Japanese Patent Application Laid-open No. 8-36502, when a destination server for switching from an active system to a standby system is selected, a hardware failure history acquired in advance is taken into consideration so that a server with a lower probability of system down due to hardware may be selected.

### SUMMARY OF THE INVENTION

In Japanese Patent Application Laid-open No. 8-36502 described above, when the destination server for switching from the active system to the standby system is selected, the hardware failure history is taken into consideration so that a server with a lower probability of system down due to hardware may be selected.

On the other hand, when a server administrator selects a physical server on which an application program is to be executed or selects a physical server on which a virtual server is to be executed, reliability of the physical server as well as reliability of software such as an operating system (OS) and a virtualization module (hypervisor) running on the physical server are important factors in selecting the server. Further, also when a physical server is selected for running an OS, operation records of OSs that have been installed in the past are important factors. However, in Japanese Patent Application Laid-open No. 8-36502, the reliability of software is not taken into consideration, and there has been a problem in that an appropriate physical server for allocating resources cannot be selected by the server administrator.

A representative example of this invention is as follows. Specifically, configuration information, failure information, and running information of hardware and software installed in a physical server are acquired while life cycle information of the physical server is also taken into consideration, and indices of reliability of the hardware and the software are calculated. Further, based on the indices of the reliability of the hardware and the software, overall reliability of the physical server is evaluated.

According to this invention, the reliability of the hardware and the software installed in the physical server is expressed in numerical values while the life cycle information of the physical server is also taken into consideration, and based on the indices obtained by expressing the reliability in the numerical values, the overall reliability of the physical server is provided. Therefore, the reliability of the physical server to which tasks are allocated may be evaluated with higher accuracy.

### BRIEF DESCRIPTION OF THE DRAWINGS

FIG. 1 illustrates a configuration of a computer system according to an embodiment of this invention.

FIG. 2 illustrates a configuration of a management server according to the embodiment of this invention.

FIG. 3 illustrates a configuration of a physical server according to the embodiment of this invention.

FIG. 4 schematically illustrates an operation according to the embodiment of this invention.

FIG. 5 illustrates details of a server management table according to the embodiment of this invention.

FIG. 6 illustrates details of a virtual server management table according to the embodiment of this invention.

FIG. 7 illustrates details of a component classification table according to the embodiment of this invention.

FIG. 8 illustrates details of a log classification table according to the embodiment of this invention.

FIG. 9 illustrates details of a life cycle classification table according to the embodiment of this invention.

FIG. 10 illustrates details of a running history information management table according to the embodiment of this invention.

FIG. 11 illustrates details of a server allocation management table according to the embodiment of this invention.

FIG. 12 illustrates details of a configuration information evaluation table according to the embodiment of this invention.

FIG. 13 illustrates details of a failure information evaluation table according to the embodiment of this invention.

FIG. 14 illustrates details of a running information evaluation table according to the embodiment of this invention.

FIG. 15 illustrates details of a reliability evaluation weight table according to the embodiment of this invention.

FIG. 16 illustrates details of a reliability display screen according to the embodiment of this invention.

FIG. 17 is a flowchart of processing performed by a server information acquisition module according to the embodiment of this invention.

FIG. 18 is a flowchart of processing performed by a life cycle information acquisition module according to the embodiment of this invention.

FIG. 19 is a flowchart of processing performed by a configuration information acquisition module according to the embodiment of this invention.

FIG. 20 is a flowchart of processing performed by a running history information acquisition module according to the embodiment of this invention.

FIG. 21 is a flowchart of processing performed by a latest failure information acquisition module according to the embodiment of this invention.

FIG. 22 is a flowchart of processing performed by a reliability evaluation module according to the embodiment of this invention.

FIG. 23 is a flowchart of processing performed by a physical server reliability calculation module according to the embodiment of this invention.

FIG. 24 is a flowchart of processing performed by a virtualized environment reliability calculation module according to the embodiment of this invention.

FIG. 25 is a flowchart of processing performed ion Step 2404 of FIG. 24 as a subroutine.

### DETAILED DESCRIPTION OF THE PREFERRED EMBODIMENT

Next, an embodiment of this invention is described in detail with reference to the accompanying drawings.

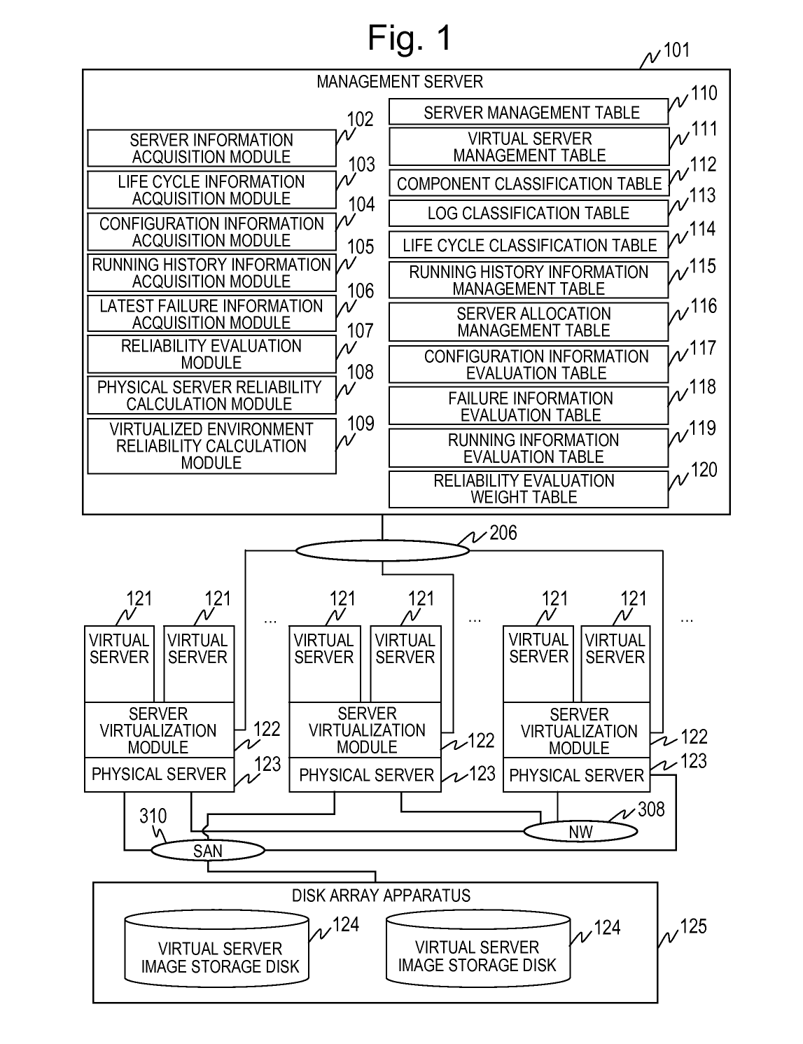

FIG. 1 is an overall diagram of the embodiment of this invention. A center of control in this embodiment is a management server 101. The management server 101 includes a server information acquisition module 102, a life cycle information acquisition module 103, a configuration information acquisition module 104, a running history information acquisition module 105, a latest failure information acquisition module 106, a reliability evaluation module 107, a physical server reliability calculation module 108, a virtualized environment reliability calculation module 109, a server management table 110, a virtual server management table 111, a component classification table 112, a log classification table 113, a life cycle classification table 114, a running history information table 115, a server allocation management table 116, a configuration information evaluation table 117, a failure information evaluation table 118, a running information evaluation table 119, and a reliability evaluation weight table 120. It should be noted that the server information acquisition module 102 may include the life cycle information acquisition module 103, the configuration information acquisition module 104, and the running history information acquisition module 105.

The management server 101 manages physical servers 123, server virtualization modules 122, virtual servers 121, a disk array apparatus 125, and virtual server image storage disks 124. In this case, the server virtualization module 122 is constituted of, for example, a hypervisor or a virtual machine monitor (VMM) and has a function of running a plurality of virtual servers 121 on the physical server 123 so that a plurality of servers can be integrated into a single physical server 123.

The disk array apparatus 125 is coupled to the physical servers 123 via a storage area network (SAN) 310. The disk array apparatus 125 includes the virtual server image storage disks 124 in which programs to be executed by the virtual servers 121 are stored. In the embodiment of this invention, the management server 101 constitutes a system for calculating reliability of the physical servers 123.

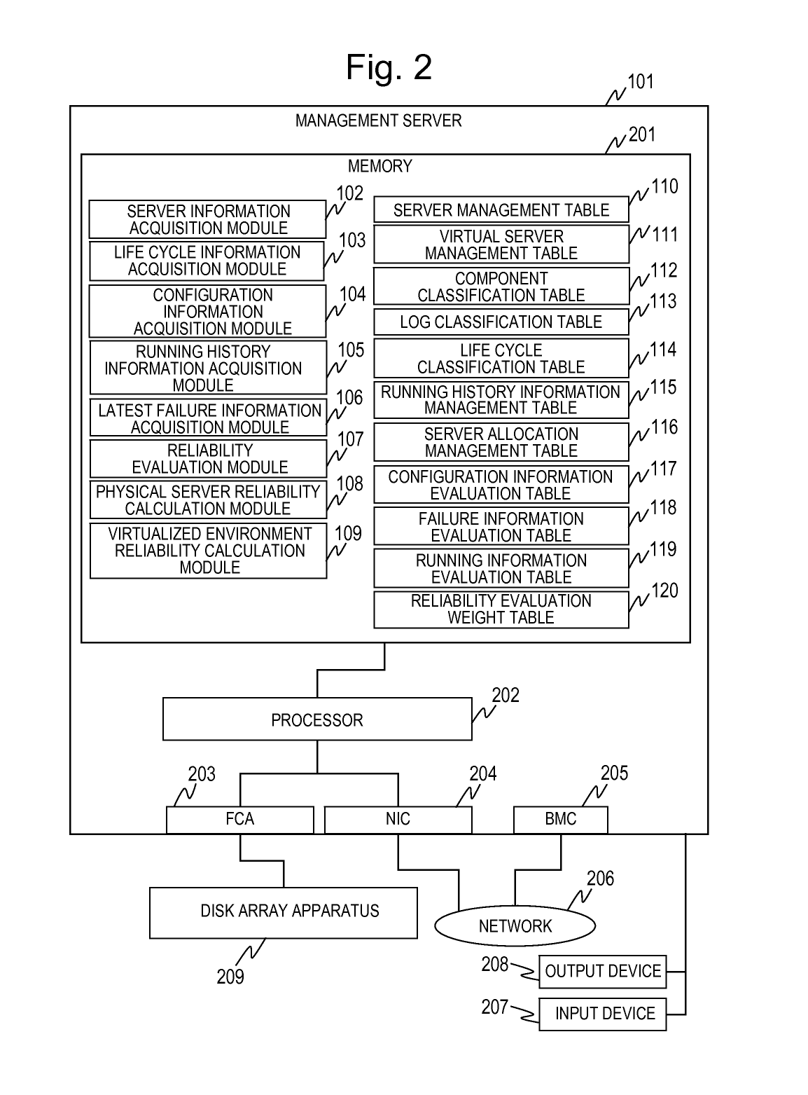

FIG. 2 illustrates a configuration of the management server 101 according to this invention. The management server 101 includes a memory 201, a processor 202, a fibre channel adapter (FCA) 203, a network interface card (NIC) 204, a baseboard management controller (BMC) 205, an input device 207, and an output device 208. The processor 202 executes various programs stored in the memory 201. The FCA 203 is coupled to a disk array apparatus 209 via the SAN 310. The NIC 204 and the BMC 205 are coupled to a network 206. The NIC 204 mainly communicates to/from the various programs on the memory 201, and the BMC 205 is used to detect a failure or the like of the management server and communicate to/from another server via the network 206. In this embodiment, the NIC 204 and the BMC 205 are coupled to the same network 206, but may be coupled to different networks. For example, the NIC 204 may be coupled to an application network, and the BMC 205 may be coupled to a management network. Further, one FCA 203 and one NIC 204 are illustrated, but a plurality of the FCAs 203 and a plurality of the NICs 204 may be provided.

The memory 201 stores the server information acquisition module 102, the life cycle information acquisition module 103, the configuration information acquisition module 104, the running history information acquisition module 105, the latest failure information acquisition module 106, the reliability evaluation module 107, the physical server reliability calculation module 108, the virtualized environment reliability calculation module 109, the server management table 110, the virtual server management table 111, the component classification table 112, the log classification table 113, the life cycle classification table 114, the running history information table 115, the server allocation management table 116, the configuration information evaluation table 117, the failure information evaluation table 118, the running information evaluation table 119, and the reliability evaluation weight table 120. The processor 202 executes the programs stored in the memory 201.

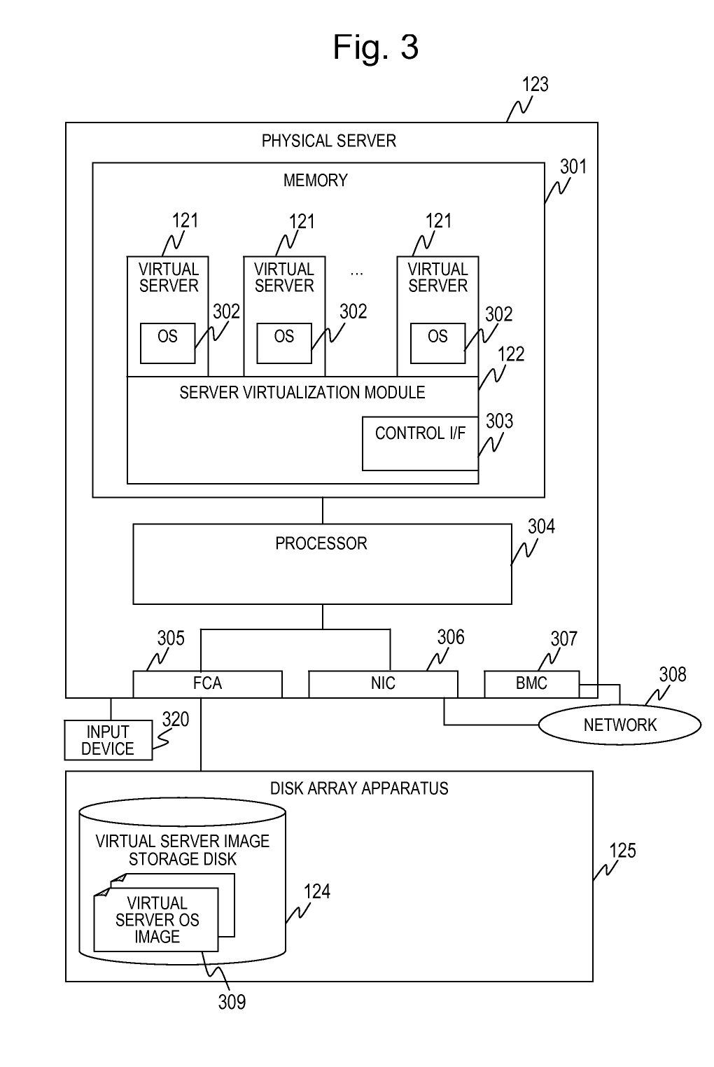

FIG. 3 illustrates a detailed configuration of the physical server 123 on which the server virtualization module 122 to be managed by the management server 101 runs. The physical server 123 includes a memory 301, a processor 304, a fibre channel adapter (FCA) 305, a network interface card (NIC) 306, a baseboard management controller (BMC) 307, and an input device 320.

The processor 304 executes various programs stored in the memory 301. The FCA 305 is coupled to the disk array apparatus 125 via the SAN 310. The NIC 306 and the BMC 307 are coupled to a network 308. The NIC 306 mainly communicates to/from the various programs on the memory 301, and the BMC 307 is used to detect a failure or the like of the physical server 123 and communicate to/from the management server 101 or another server via the network 308. The BMC 307 also controls a power supply to the physical server 123 in response to a command from the management server 101. In this embodiment, the NIC 306 and the BMC 307 are coupled to the same network 308, but may be coupled to different networks. Further, one FCA 305 and one NIC 306 are illustrated, but a plurality of the FCAs 305 and a plurality of the NICs 306 may be provided.

The server virtualization module 122 runs on the memory 301 so that computer resources of the physical server 123 may be divided or shared to construct a plurality of virtual servers 121. The virtual servers 121 may run operating systems (OSs) 302 independently of one another.

The processor 304 may execute the server virtualization module 122 to construct the virtual servers 121. The server virtualization module 122 reads a predetermined virtual server OS image 309, which is set in advance for each of the virtual servers 121, in the virtual server image storage disk 124, and constructs the virtual servers 121 which are independent of one another. By providing the virtual server OS image 309 for each of the virtual servers 121, it is possible to run a plurality of different OSs or application programs on a single physical server 123.

A control interface (I/F) 303 of the server virtualization module 122 is a virtual network interface of the server virtualization module 122, for controlling the server virtualization module 122 from the outside (management server 101) via the NIC 306 and the network 308. The server virtualization module 122 may receive a command from the management server 101 via the control I/F 303 to create or delete a virtual server 121. The input device 320 is used by an administrator to set life cycle information manually.

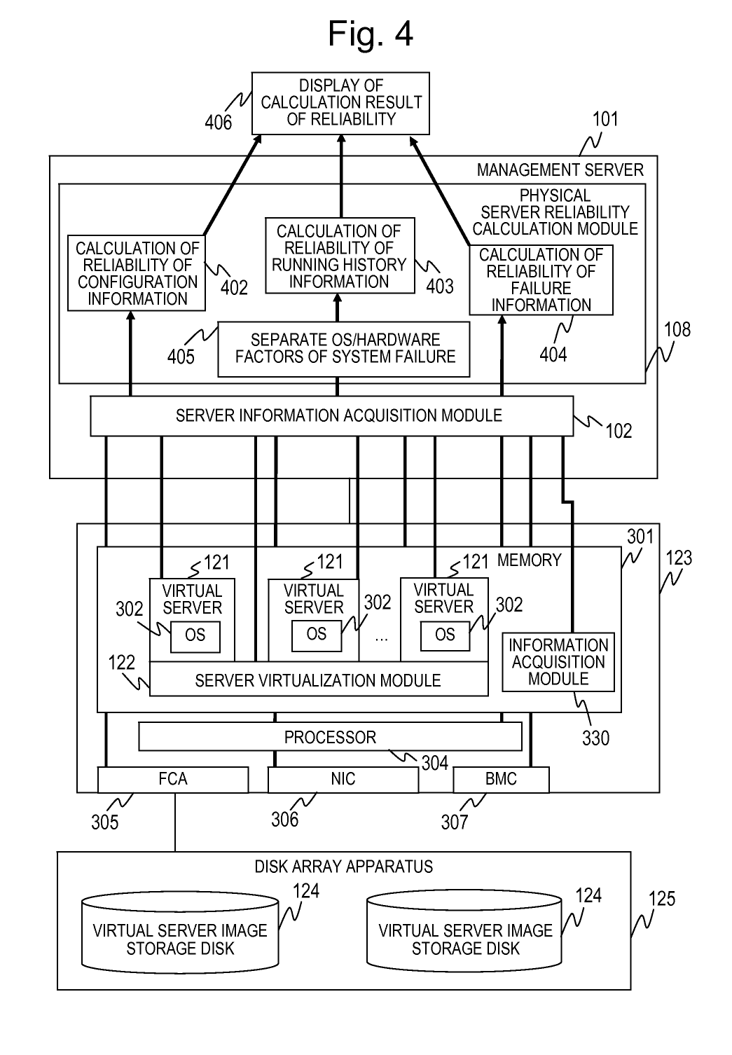

FIG. 4 schematically illustrates an operation according to this invention. The management server 101 is coupled to the physical server 123 to be managed thereby via a network, and the server information acquisition module 102 may acquire configuration information, failure information, running information, the life cycle information, and the like of the components of the physical server 123 and transfer the acquired information to the physical server reliability calculation module 108. It should be noted that the server information acquisition module 102 acquires those pieces of information via the life cycle information acquisition module 103, the configuration information acquisition module 104, and the running history information acquisition module 105 as described later.

In this embodiment, the configuration information acquired by the physical server reliability calculation module 108 from the physical server 123 includes, for example, information on hardware and software from the server virtualization module 122 and the OSs 302 of the virtual servers 121.

Similarly, the failure information acquired by the physical server reliability calculation module 108 from the physical server 123 includes, for example, failures detected by the BMC 307 and errors detected by the server virtualization module 122 and the OSs 302 of the virtual servers 121.

Similarly, log information acquired by the physical server reliability calculation module 108 from the physical server 123 includes, for example, log information of the server virtualization module 122, log information of the OSs 302 of the virtual servers 121, log information of the BMC 307, and in an environment in which the server virtualization module 122 is not present, log information of an OS on the physical server 123.

It should be noted that in the following description, the log information of the server virtualization module 122 and the OSs 302 of the virtual servers 121, and the log information of the BMC 307 and the OS are collectively referred to as the log information of the physical server 123. The management server 101 treats accumulation of the log information acquired from the physical server 123 as running history information.

In this schematic diagram, only one physical server 123 is illustrated, but a plurality of the physical servers 123 may be provided. In this invention, when the management server 101 acquires the configuration information, the failure information, the running information, and the life cycle information of the components of the physical server 123, the physical server reliability calculation module 108 performs calculation 402 of reliability of the configuration information, calculation 403 of reliability of the running history information, and calculation 404 of reliability of the failure information of the physical server 123, and based on those pieces of information, performs display (406) of the calculation result of the reliability of the physical server 123. It should be noted that in calculating the reliability of the running history information, an OS factor and a hardware factor are separated (405) as factors of system failures as described later.

It should be noted that when the physical server 123 has the life cycle information of “discarded” and is shut down, the management server 101 may transmit an OS for booting and an information acquisition module 330 as an agent for acquiring the configuration information and the like so that the information acquisition module 330 is run on the physical server 123 having the life cycle information of “discarded” and then the server information acquisition module 102 may acquire the above-mentioned information.

Alternatively, the information acquisition module 330 may be resident on the physical server 123 or on the server virtualization module 122.

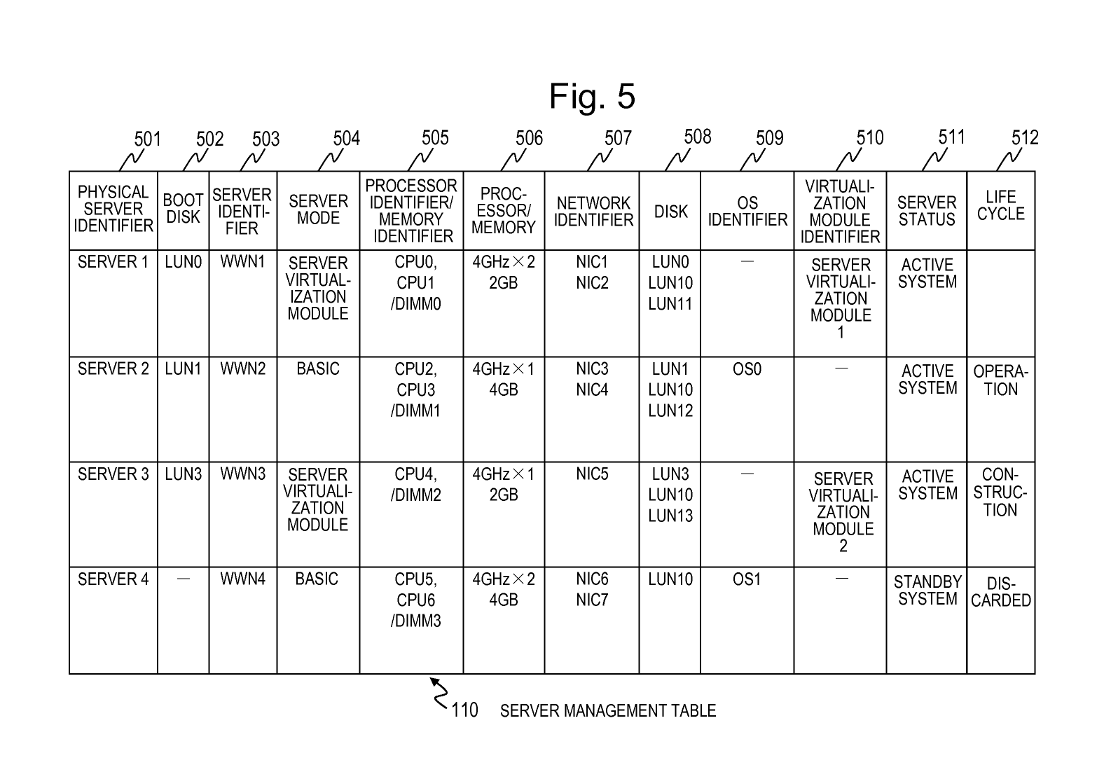

FIG. 5 illustrates details of the server management table 110. The server management table stores detailed information on the physical servers 123.

A physical server identifier 501 stores an identifier for identifying a physical server 123. A boot disk 502 indicates a location of a boot disk of the physical server 123. A server identifier 503 indicates a unique identifier of the FCA coupled to the disk array apparatus. A server mode 504 indicates a running status of the physical server 123, and stores information for determining whether or not the server virtualization module 122 is running. For example, a physical server 123 having the server mode 504 of “server virtualization module” indicates that at least one virtual server 121 may be executed. On the other hand, a physical server 123 having the server mode 504 of “basic” indicates that one OS may be executed.

A processor identifier and memory identifier 505 stores identifiers for identifying the processor 304 and the memory 301. A processor and memory 506 stores performance information such as frequency information and the number of cores of the processor 304 and a memory capacity of the physical server 123. A network identifier 507 stores information for identifying the NIC 306 included in the physical server 123. When the physical server 123 includes a plurality of NICs 306, a plurality of identifiers are stored.

A disk 508 stores an identifier of a disk included in (or accessible to) the physical server 123. An OS identifier 509 stores an identifier for identifying an OS. A virtualization module identifier 510 stores, when the server virtualization module 122 is running on the physical server 123, an identifier for identifying the server virtualization module 122. The virtualization module identifier 510 is associated with the virtual server management table 111 to be described later.

A server status 511 indicates a status or role of the physical server 123, and in the illustrated example, stores information indicating whether the physical server 123 is an active system or a standby system. The server status 511 may be set by the administrator or the like who uses the management server 101, or may be updated when the management server 101 switches the systems. A life cycle 512 stores information for identifying the life cycle information of the physical server 123.

The pieces of information in the above-mentioned server management table 110 may be obtained by, instead of reflecting the configuration information and the life cycle information, which are acquired by the server information acquisition module 102, storing values set by the administrator or the like of the management server 101 with the input device 207.

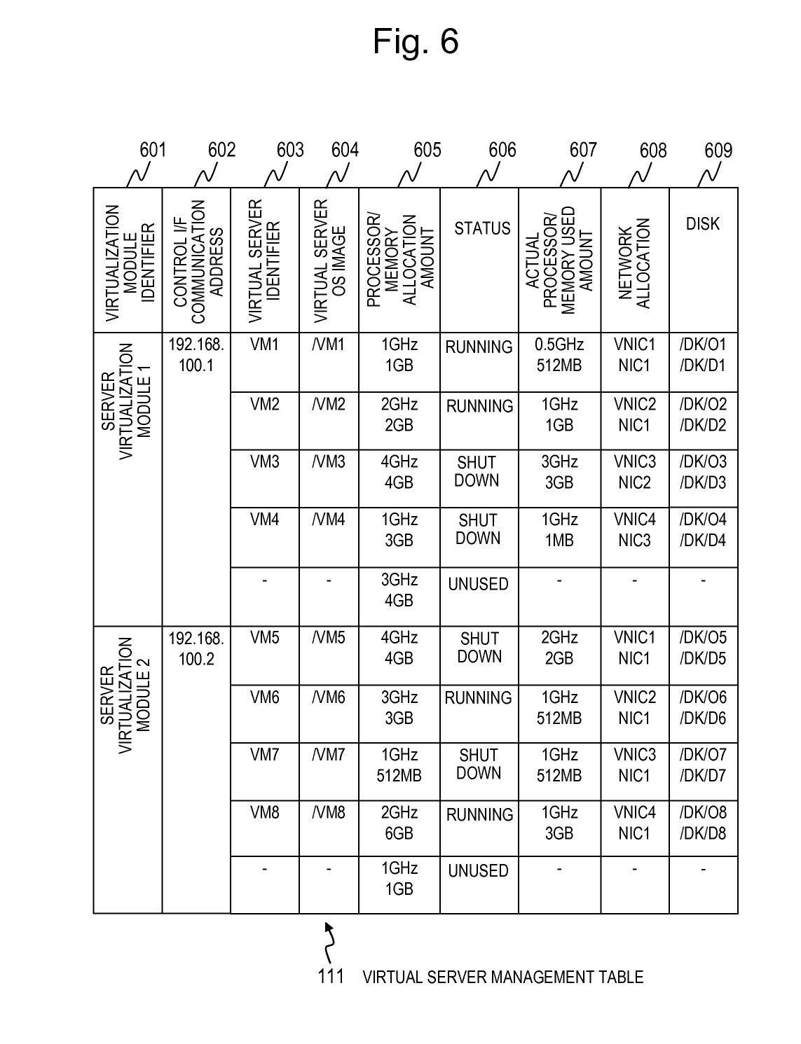

FIG. 6 illustrates details of the virtual server management table 111. The virtual server management table 111 stores detailed information on the server virtualization modules 122 and the virtual servers 121. It should be noted that allocation of resources of the physical servers 123 to the virtual servers 121 is executed by a management module (not shown) of the management server 101. The allocation of the resources to the virtual servers 121 may be performed by applying a publicly-known or well-known technology, and is not described in detail in this embodiment.

A virtualization module identifier 601 stores information for identifying a plurality of server virtualization modules 122 managed by the management server 101. A control I/F 602 stores a network address, which serves as access information for controlling the server virtualization module 122 from the outside.

A virtual server identifier 603 stores a unique identifier for each of the virtual servers 121 allocated by each of the server virtualization modules 122. A virtual server OS image 604 stores which OS image is used to boot the virtual server 121, that is, a location of the OS image. A processor and memory allocation amount 605 indicates an amount of computer resources allocated to the virtual server 121. A status 606 stores whether or not the virtual server 121 is currently running. An actual processor and memory used amount 607 stores capacities of the processor 304 and the memory 301 which are actually used by the virtual server 121. The actual used amount 607 may be acquired by providing, for example, means (not shown) for collecting the performance information regularly from the server virtualization module 122, the OS running on the virtual server 121, and the like. Alternatively, a method of storing an average used amount per unit time in the actual used amount 607 and other such methods may be contemplated.

A network allocation 608 stores allocation information of an identifier of a virtual NIC allocated to the virtual server 121 and the NIC 306 (physical NIC) included in the physical server 123 corresponding to the virtual NIC. A disk 609 stores locations of an OS image file and an image file for storing data, which are allocated to the virtual server.

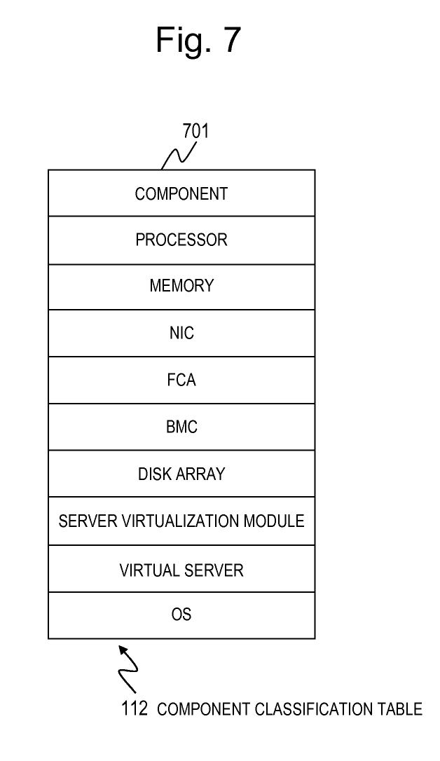

FIG. 7 illustrates details of the component classification table 112. The component classification table 112 stores information used by the running history information acquisition module 105 for classifying the components of the physical server 123. A component 701 stores names of components constituting the physical server 123. In the illustrated example, the components constituting the physical server 123 are the processor, the memory, the NIC, the FCA, the BMC, the disk array, the server virtualization module, the virtual server, and the OS.

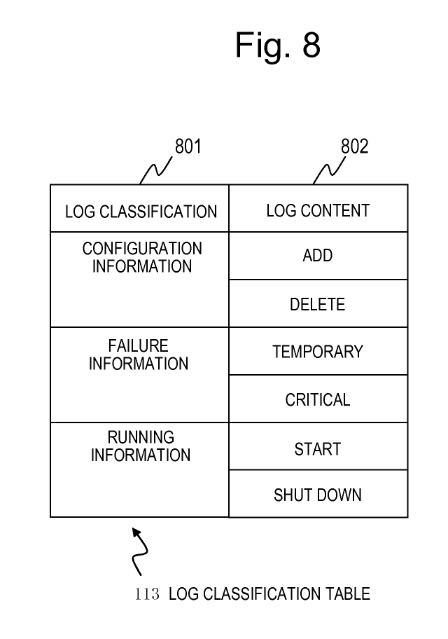

FIG. 8 illustrates details of the log classification table 113. The log classification table 113 stores identifiers used by the running history information acquisition module 105 for classifying the log information acquired from the physical servers 123 and the server virtualization modules 122.

A log classification 801 stores identifiers when log contents acquired from the physical servers 123 and the like are classified into a log of “configuration information”, a log of “failure information”, and a log of “running information”. A log content 802 stores detailed contents of the classified logs. In this embodiment, the log classified into the configuration information is illustrated as having detailed log contents of “add” and “delete” of a component as examples. The log classified into “failure information” is illustrated as having detailed log contents of “temporary” and “critical” as examples. It should be noted that the log having the log content of “temporary” indicates a failure which does not lead to a shutdown of the physical server 123, and the log having the log content of “critical” indicates a failure in which the physical server 123 is shut down. The log classified into “running information” is illustrated as having detailed log contents of “start” and “shut down” of the physical server 123 as examples.

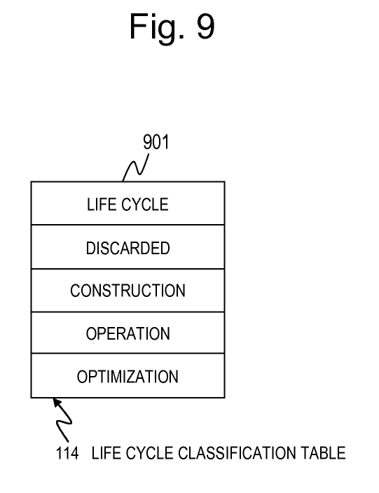

FIG. 9 illustrates details of the life cycle classification table 114. The life cycle classification table 114 stores information used by the life cycle information acquisition module 103 for classifying phases of the life cycle information of the physical server 123 as described above. It should be noted that the life cycle information is information indicative of the operation status of the physical server 123.

A life cycle 901 stores information for discriminating the life cycle information of the physical server 123. In this embodiment, the life cycle information is classified into “discarded”, “construction”, “operation”, and “optimization” as described above.

The life cycle information of “discarded” means a period from when the life cycle of the physical server 123 has gone around to when the physical server 123 is reused next time. The life cycle information of “discarded” indicates a status in which the physical server 123 is not performing a task, in other words, a status in which the physical server 123 is not used.

The life cycle information of “construction” means a period in which the physical server 123 or the virtual server 121 is actually being constructed. The “construction” in this embodiment represents a period also including a planning and design stage for using the physical server. The life cycle information of “construction” indicates a status in which the physical server 123 is preparing for performing a task, and for example, a period in which the server virtualization module 122 is allocating a virtual MAC to the virtual server 121 is included in the status of “construction”.

The life cycle information of “operation” means a period in which the physical server 123 is actually in operation. The life cycle information of “operation” indicates a status in which the physical server 123 executes the OSs 302 or executes the OSs 302 on the virtual servers 121 to perform tasks.

The life cycle information of “optimization” means a period in which, at a stage where the operation has been progressed, a server resource is added or deleted in order to level the loads. The life cycle information of “optimization” indicates a status in which the configuration of the physical server 123, to which the life cycle information of “operation” has been set once, is changed, and indicates, for example, a period in which an addition of a hardware resource such as the memory 301 or a change to the resource allocation to the virtual server 121 is being made.

Such life cycle information is set by the administrator or the like for each of the physical servers 123.

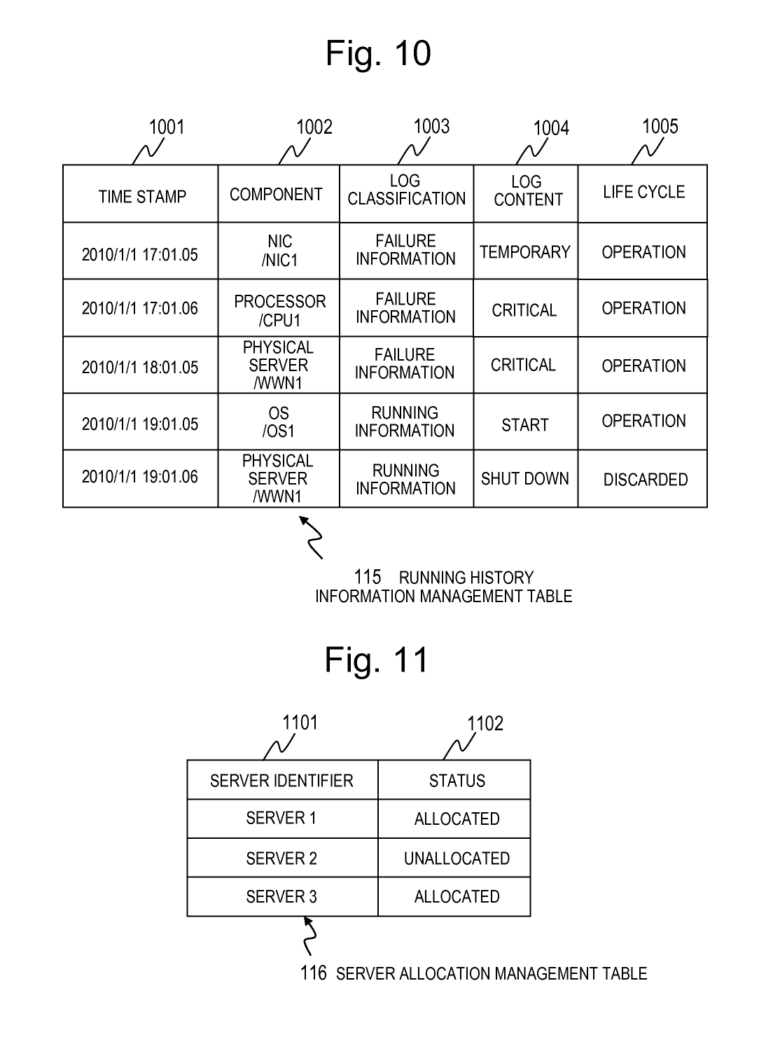

FIG. 10 illustrates details of the running history information management table 115. The running history information management table 115 stores a result obtained when the running history information acquisition module 105 classifies the log information of the physical server 123 by using the component classification table 112, the log classification table 113, and the life cycle classification table 114.

A time stamp 1001 stores a time of generation of the acquired log information. Regarding the time of generation of the log information, the time stamp recorded when the log information of the physical server 123 or the like is generated may be used as the time of generation of the log information. A component 1002 stores a name of a component corresponding to the log information and an identifier of the component. A log classification 1003 stores the result obtained when the running history information acquisition module 105 classifies the log information acquired from the physical server 123 by using the log classification table 113. A log content 1004 stores the result obtained when the running history information acquisition module 105 classifies the log information acquired from the physical server 123 by using the log classification table 113. A life cycle 1005 stores the result obtained when the life cycle information acquisition module 103 classifies the life cycle information acquired from the physical server 123 by using the life cycle classification table 114.

FIG. 11 illustrates details of the server allocation management table 116. In the server allocation management table 116, information on the allocation status of a task to the physical server 123 is stored by the configuration information acquisition module 104. A server identifier 1101 stores information for identifying the physical server 123. A status 1102 stores any one of “allocated” and “unallocated” as the information on the allocation status of a task to the physical server 123. It should be noted that the allocation of the task (application program) to the physical server 123 or the virtual server 121 is performed by the management module (not shown) of the management server 101. It should be noted that the allocation of the task may be performed by applying a publicly-known or well-known technology, and is not described in detail in this embodiment.

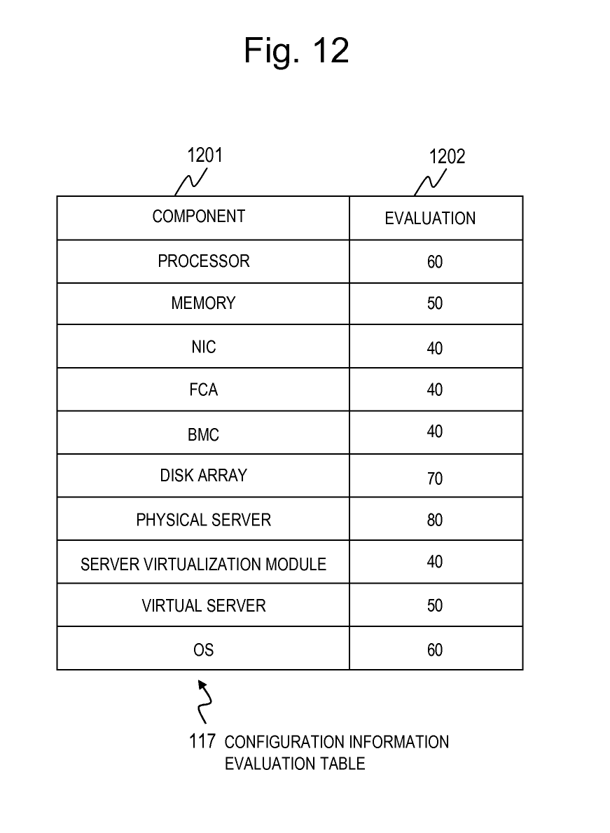

FIG. 12 illustrates details of the configuration information evaluation table 117. The configuration information evaluation table 117 stores a result obtained when the physical server reliability calculation module 108 calculates indices of reliability of the components constituting the physical server 123 based on identifiers of the components.

A component 1201 stores names of components of the physical server 123. An evaluation 1202 stores an index obtained when the physical server reliability calculation module 108 expresses the reliability as a score (numerical value) based on the identifier of each component of the physical server 123. This embodiment is based on the premise that the physical server reliability calculation module 108 has successfully acquired the correspondence relationship between the identifier of each component and the evaluation 1202 in advance. It should be noted that the evaluation 1202 stores the index of the reliability. For example, the physical server reliability calculation module 108 acquires in advance a table and a function for calculating the evaluation 1202 from the type and the performance information of each component of the physical server 123. Then, the physical server reliability calculation module 108 calculates the evaluation 1202 from the information of each component stored in the server management table 110 and the table. As an example, in a case where the component 1201 is a processor, the physical server reliability calculation module 108 sets the evaluation 1202 higher as an operation frequency of the processor becomes higher, and sets the evaluation 1202 higher as the number of cores of the processor becomes larger. Further, in a case where the component 1201 is a memory, the physical server reliability calculation module 108 sets the evaluation 1202 higher as the capacity becomes larger.

In the configuration information evaluation table 117, the evaluation 1202 stores the index of the reliability of each component from all pieces of log information on the physical server 123. Therefore, the index of the reliability of the configuration for each of the current components (hardware or software) and the index of the reliability of the configuration for each of the past components (hardware or software) are stored. It should be noted that the configuration information evaluation table 117 may be displayed on the output device 208 of the management server 101.

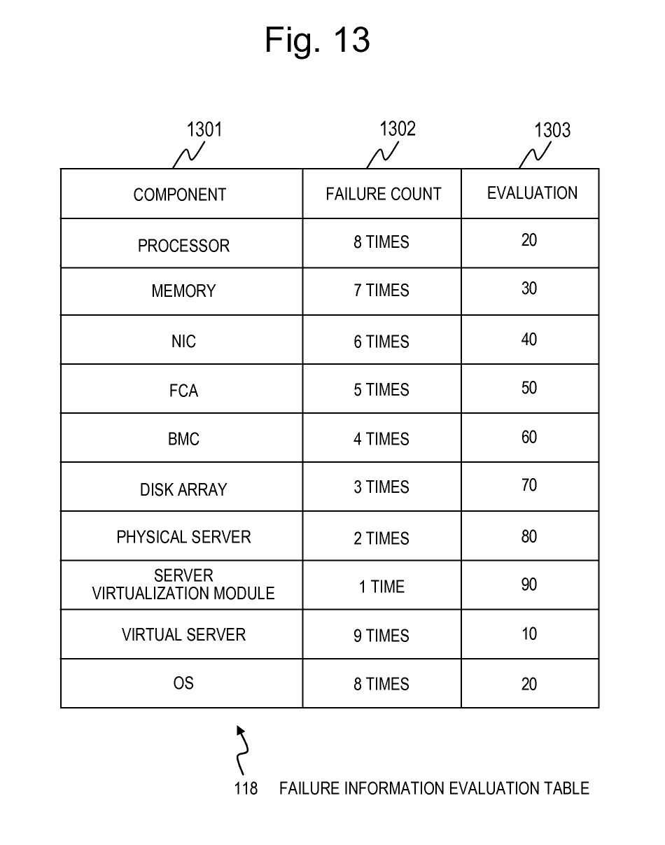

FIG. 13 illustrates details of the failure information evaluation table 118. The failure information evaluation table 118 stores the number of times the failure has occurred in each component constituting the physical server 123, and a result obtained when the physical server reliability calculation module 108 expresses the index of the reliability of each component as a score based on the failure count.

A component 1301 stores a name of the component constituting the physical server 123. A failure count 1302 stores the number of times the failure has occurred in the component constituting the physical server 123. An evaluation 1303 stores a failure information evaluation, which is an index obtained when the physical server reliability calculation module 108 expresses the reliability as a score (numerical value) based on the failure count of each component of the physical server 123.

In this embodiment, the failure information evaluation of each component is calculated by the following expression:

(failure information evaluation of component)=100−(number of times failure has occurred)×10 (1)

In the failure information evaluation table 118, the evaluation 1303 stores the index of the reliability against the failure of each component from all pieces of log information on the physical server 123. Therefore, the index of the reliability against the failure of each of the current components (hardware or software) and the index of the reliability against the failure of each of the past components (hardware or software) are stored. It should be noted that the failure information evaluation table 118 may be displayed on the output device 208 of the management server 101.

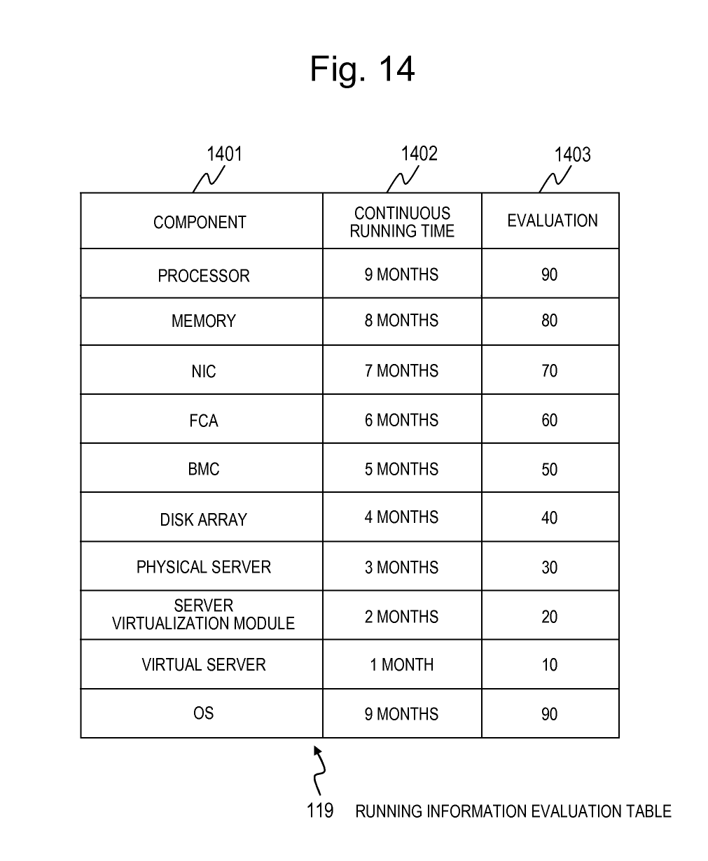

FIG. 14 illustrates details of the running information evaluation table 119. The running information evaluation table 119 stores a continuous running time of each component constituting the physical server 123, and a result obtained when the physical server reliability calculation module 108 expresses the index of the reliability of each component as a score (numerical value) based on the continuous running time. A component 1401 stores a name of the component constituting the physical server 123. A continuous running time 1402 stores the continuous running time of the component constituting the physical server 123. An evaluation 1403 stores a running information evaluation, which is an index obtained when the physical server reliability calculation module 108 expresses the reliability of each component of the physical server 123 as a score based on the continuous running time of each component of the physical server 123.

In this embodiment, the running information evaluation of each component is calculated by the following expression:

(running information evaluation of component)=(maximum number of months of continuous running)×10 (2)

In the running information evaluation table 119, the evaluation 1403 stores the index of the reliability of the running for each component from all pieces of log information on the physical server 123. Therefore, the index of the reliability of the running for each of the current components (hardware or software) and the index of the reliability of the running for each of the past components (hardware or software) are stored. It should be noted that the running information evaluation table 119 may be displayed on the output device 208 of the management server 101.

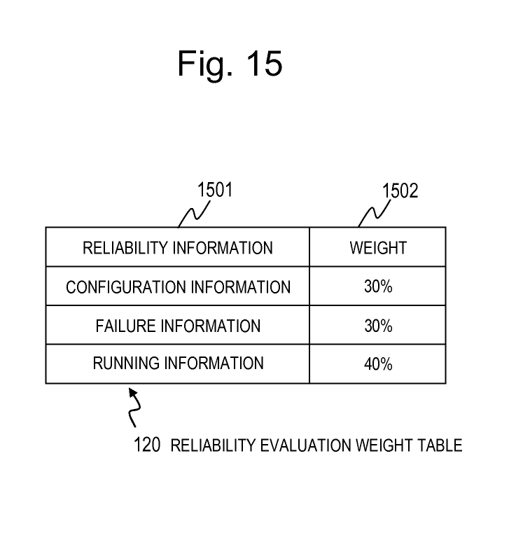

FIG. 15 illustrates details of the reliability evaluation weight table 120. The reliability evaluation weight table 120 stores information for weighting the configuration information, the failure information, and the running information when the physical server reliability calculation module 108 calculates the reliability of the physical server 123. Reliability information 1501 is information based on which the reliability of the physical server 123 is evaluated, and stores “configuration information”, “failure information”, or “running information”. A weight 1502 stores information for weighting in evaluating the reliability of the physical server 123. In this embodiment, weights are allocated so that the weights for the “configuration information”, the “failure information”, and the “running information” total 100%. This table may be provided manually by the system administrator with the input device 207 of the management server 101.

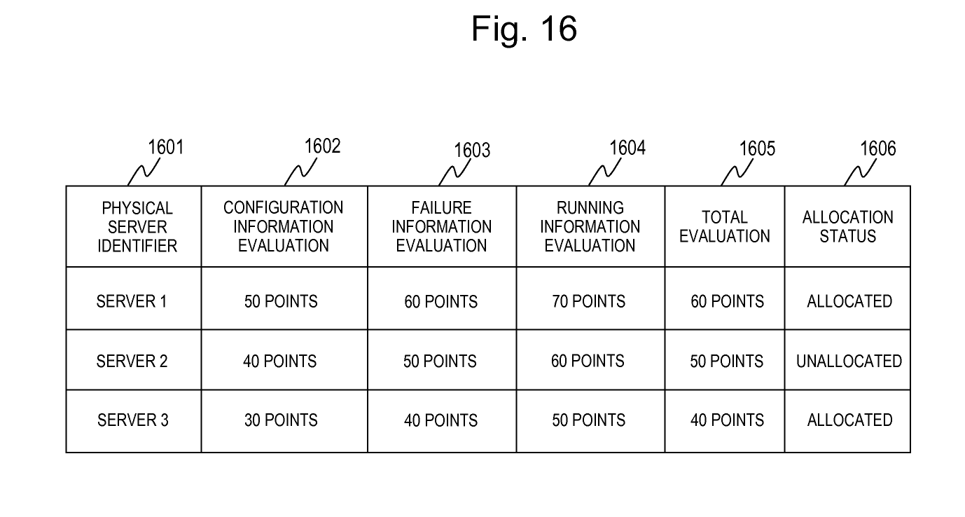

FIG. 16 illustrates details of a reliability display screen. The reliability display screen is a result obtained by outputting the physical server 123 of which the reliability is evaluated, indices obtained by expressing the reliability of the configuration information, the failure information, and the running information as scores, and an index of the overall reliability of the physical server 123 obtained by expressing the total evaluation as a score to the output device 208 along with the allocation status.

A physical server identifier 1601 stores an identifier of the physical server 123 of which the reliability is evaluated. A configuration information evaluation 1602 stores the index of the reliability of the configuration information of the physical server 123. A failure information evaluation 1603 stores the index of the reliability of the failure information of the physical server 123. A running information evaluation 1604 stores the index of the reliability of the running information of the physical server 123. A total evaluation 1605 stores a total index of the reliability of the physical server 123 obtained by taking into account the configuration information evaluation, the failure information evaluation, and the running information evaluation of the physical server 123 and the contents of the reliability evaluation weight table 120. An allocation status 1606 stores the allocation status of the physical server 123.

In this embodiment, the configuration information evaluation, the failure information evaluation, the running information evaluation, and the total evaluation of the reliability of the physical server 123 are calculated by the following expressions:

(configuration information evaluation)=(total evaluation of components in configuration information evaluation table 117)/(number of components) (3)

(failure information evaluation)=(total evaluation of components in failure information evaluation table 118)/(number of components) (4)

(running information evaluation)=(total evaluation of components in running information evaluation table 119)/(number of components) (5)

(total evaluation)=(configuration information evaluation)×(weight of configuration information in reliability evaluation weight table)+(failure information evaluation)×(weight of failure information in reliability evaluation weight table)+(running information evaluation)×(weight of running information in reliability evaluation weight table) (6)

The reliability evaluation module 107 calculates the evaluations as the indices indicating the reliability of each of the physical servers 123 by the above-mentioned expressions (3) to (5), and further, the reliability evaluation module 107 calculates the total index as the total evaluation from the evaluations by the above-mentioned expression (6) and displays the results on the output device 208 as illustrated in FIG. 16.

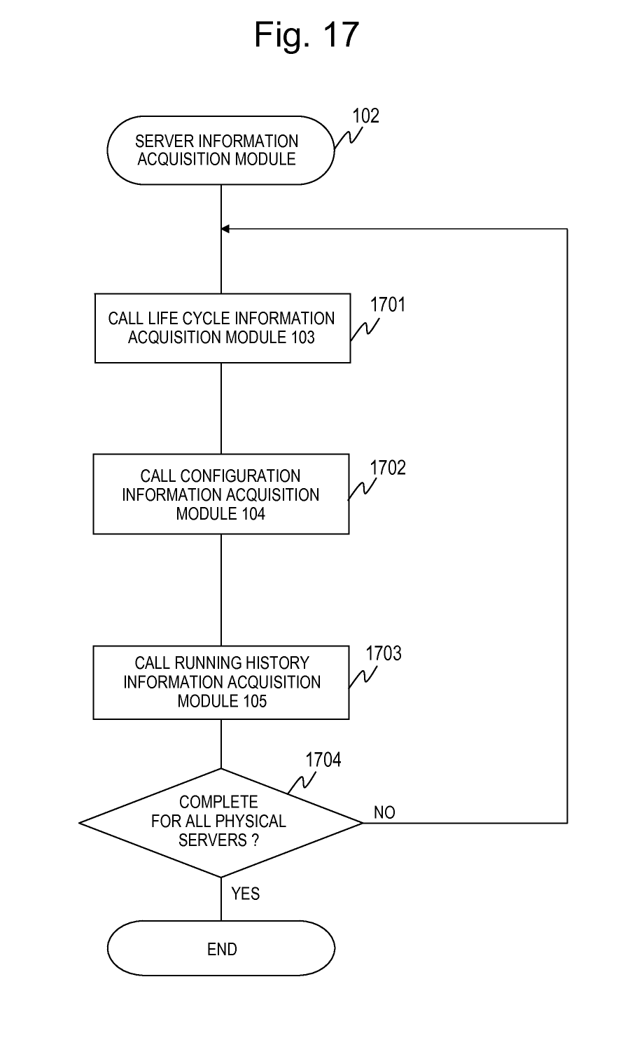

FIG. 17 is a flowchart of processing performed by the server information acquisition module 102. This processing is executed, for example, when the administrator or the like inputs a predetermined command with the input device 207 of the management server 101. Alternatively, this processing may be executed at predetermined intervals.

The server information acquisition module 102 acquires the life cycle information, the configuration information, and the running history information of the physical server 123. In Step 1701, the server information acquisition module 102 calls the life cycle information acquisition module 103 to acquire the life cycle information of the physical server 123. In Step 1702, the server information acquisition module 102 calls the configuration information acquisition module to acquire the configuration information of the physical server 123. In Step 1703, the server information acquisition module 102 calls the running history information acquisition module to acquire the running history information of the physical server 123. When there are a plurality of the physical servers 123 from which the information is to be acquired, the steps are repeated until the information acquisition is complete for all the physical servers 123.

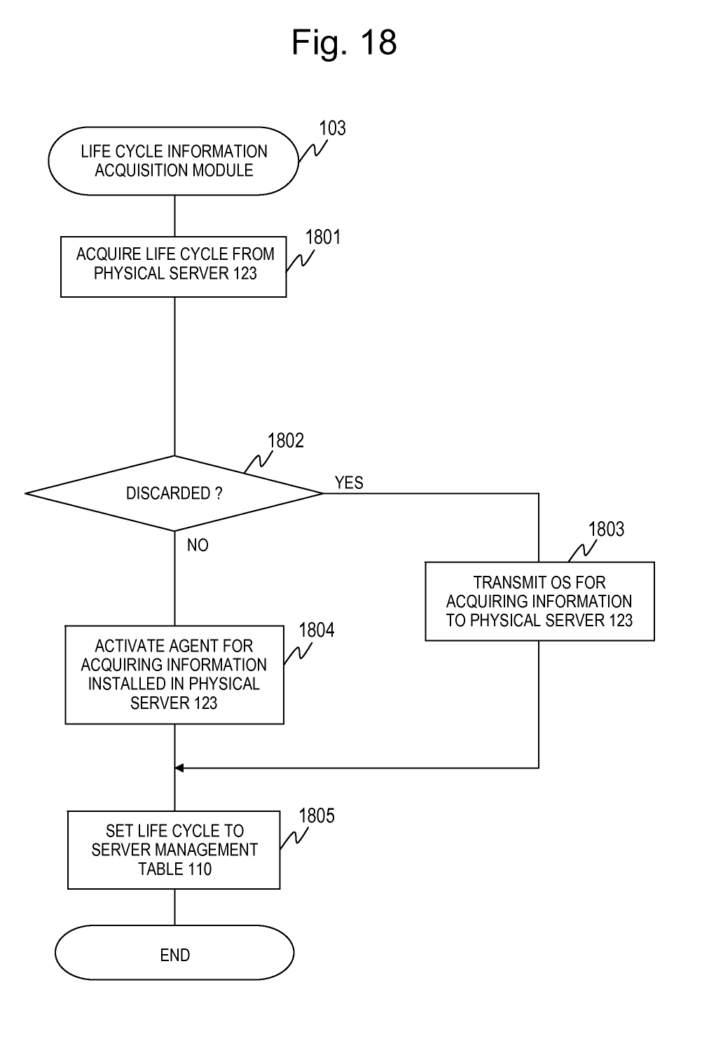

FIG. 18 is a flowchart of processing performed by the life cycle information acquisition module 103. This processing is the processing executed in Step 1701 of FIG. 17. The life cycle information acquisition module 103 determines, after acquiring the life cycle information of the physical server 123, a method of acquiring the information of the physical server.

In Step 1801, the life cycle information acquisition module 103 acquires the life cycle information from the physical server 123. The life cycle information is set manually by the administrator with the input device 320 and stored in the disk array apparatus 125. When the physical server 123 is powered off, the management server 101 issues a command to start the physical server 123 and acquires the life cycle information from the disk array apparatus 125. The method of externally powering on the physical server 123 may be realized by the existing technology of starting the physical server 123 from an external server as in a Preboot eXecution Environment (PXE) boot.

In Step 1802, the life cycle information acquisition module 103 determines whether or not the life cycle information of the physical server 123 acquired in Step 1801 is “discarded”. When the life cycle information is “discarded”, the life cycle information acquisition module 103 transmits an OS for acquiring information to the physical server 123 in Step 1803. The OS for acquiring information acquires the life cycle information in the physical server 123 and notifies the management server 101 of the acquired life cycle information. Thereafter, the life cycle information acquisition module 103 proceeds to Step 1805 to set the life cycle information to the server management table 110. When the life cycle information is not “discarded”, the life cycle information acquisition module 103 proceeds to Step 1804.

In Step 1804, the life cycle information acquisition module 103 activates an agent for acquiring information, which is installed in the physical server 123 in advance, to acquire the life cycle information. Then, the life cycle information acquisition module 103 proceeds to Step 1805 to set the life cycle information to the server management table 110.

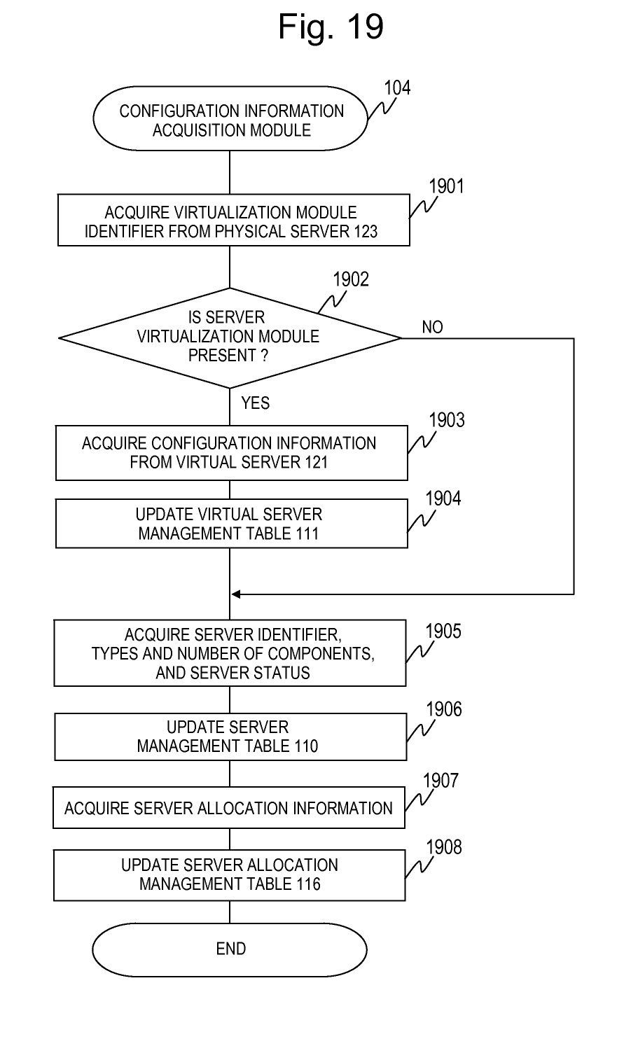

FIG. 19 is a flowchart of processing performed by the configuration information acquisition module 104. This processing is the processing executed in Step 1702 of FIG. 17. The configuration information acquisition module 104 acquires the configuration information of the physical server 123. In Step 1901, the configuration information acquisition module 104 acquires the virtualization module identifier from the physical server 123. In Step 1902, the configuration information acquisition module 104 refers to the virtualization module identifier acquired in Step 1901 to determine whether the server virtualization module 122 is present in the physical server 123. When the server virtualization module 122 is present, the configuration information acquisition module 104 acquires the configuration information from the virtual server 121 in Step 1903, and updates the virtual server management table 111 with the acquired configuration information in Step 1904.

When the server virtualization module 122 is not present, Steps 1903 and 1904 are not executed. In Step 1905, the configuration information acquisition module 104 acquires the server identifier, the types and number of the components, and the server status from the OS of the physical server 123 or the server virtualization module 122. In Step 1906, the configuration information acquisition module 104 updates the server management table 110 with the information acquired in Step 1905. In Step 1907, the configuration information acquisition module 104 acquires server allocation information from the OS of the physical server 123 or the server virtualization module 122. In Step 1908, the configuration information acquisition module 104 updates the server allocation management table 116 with the acquired server allocation information.

Through the above-mentioned processing, the virtual server management table 111, the server management table 110, and the server allocation management table 116 are updated with latest values.

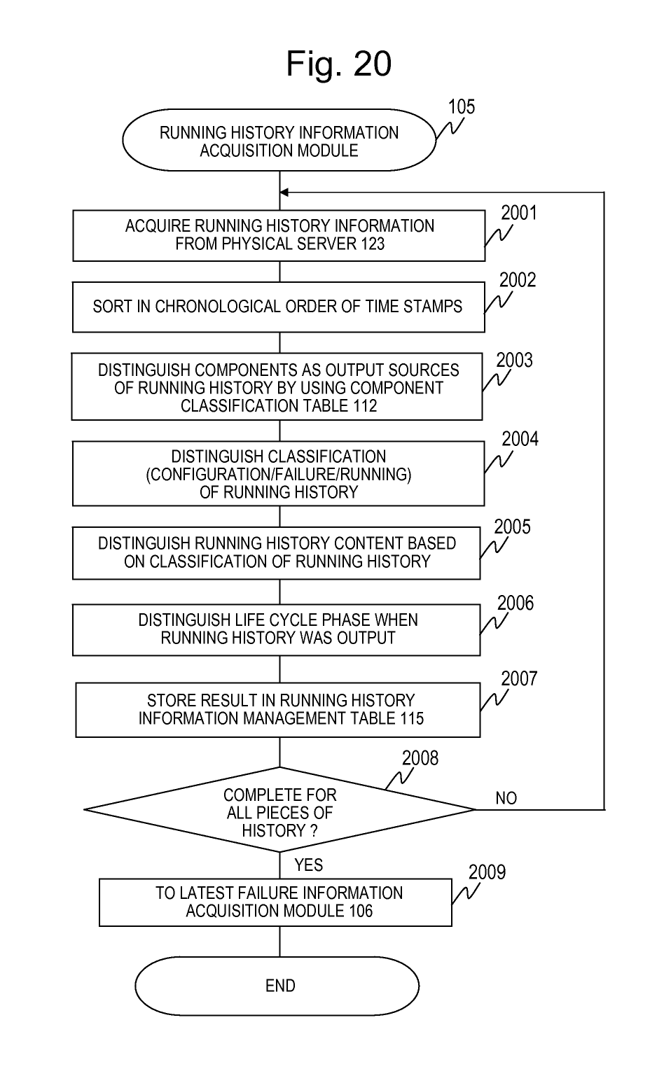

FIG. 20 is a flowchart of processing performed by the running history information acquisition module 105. This processing is the processing executed in Step 1703 of FIG. 17. The running history information acquisition module 105 uses the component classification table 112, the log classification table 113, and the life cycle classification table 114 to classify the running information acquired from the physical server 123 and register the classified running information to the running history information management table 115.

In Step 2001, the running history information acquisition module 105 acquires the running history information (log information) from the physical server 123. In Step 2002, the running history information acquisition module 105 sorts the running history information acquired in Step 2001 by time stamps. In Step 2003, the running history information acquisition module 105 distinguishes the components as output sources of the running history information by using the component classification table 112.

In Step 2004, the running history information acquisition module 105 distinguishes to which of the configuration information, the failure information, and the running information the acquired running history information belongs by using the log classification table 113. In Step 2005, the running history information acquisition module 105 distinguishes a content of the running history information based on the classification result of the running history information. The log classification table 113 is used also in this distinguishment. In Step 2006, the running history information acquisition module 105 uses the life cycle classification table 114 to classify the life cycle information when the running history information was output. In this processing, by accumulating the life cycle information and the period for each of the physical servers 123, the running history information acquisition module 105 can acquire the operation status of the physical server 123 at the time point when the running history information (log information) was generated.

In Step 2007, the running history information acquisition module 105 stores the classification result of the running history information in the running history information management table 115. In Step 2008, the running history information acquisition module 105 determines whether or not the classification of the running history information of the physical server 123 is complete. When the classification is not complete, the processing of Steps 2001 to 2008 is repeated. When the classification is complete, the running history information acquisition module 105 proceeds to Step 2009. In Step 2009, the running history information acquisition module 105 calls the latest failure information acquisition module 106.

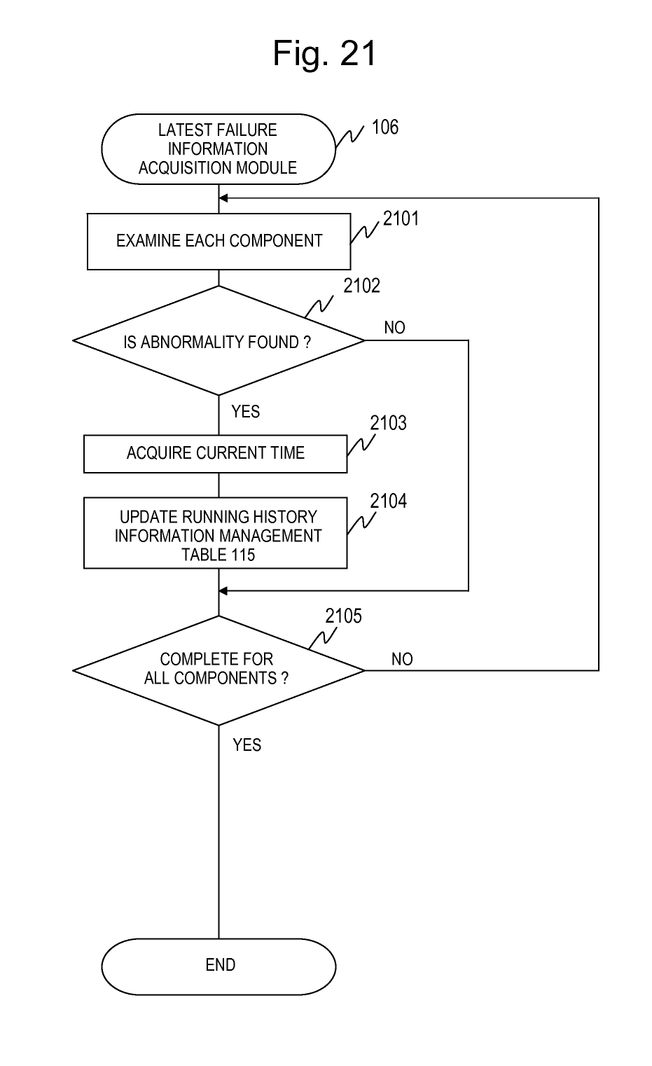

FIG. 21 is a flowchart of processing performed by the latest failure information acquisition module 106. The latest failure information acquisition module 106 actually examines each component of the physical server 123 and reflects the examination result in the running history information management table 115.

In Step 2101, the latest failure information acquisition module 106 examines each component of the physical server 123. In determining the component to be examined, the latest failure information acquisition module 106 refers to the component classification table 112. The examination of each component is carried out by the above-mentioned agent, OS for acquiring information, or the like and the examination result is notified to the management server 101.

When no abnormality is found in determining the examination result of each component in Step 2102, the latest failure information acquisition module 106 proceeds to Step 2105. In Step 2105, the latest failure information acquisition module 106 determines whether or not the examination is complete for all the components, and when the examination is not complete for all the components, the latest failure information acquisition module 106 returns to Step 2101 to carry out the examination of the next component.

When an abnormality is found in the examination result of a component, the latest failure information acquisition module 106 proceeds to Step 2103. In Step 2103, the latest failure information acquisition module 106 acquires the current time. In Step 2104, the latest failure information acquisition module 106 reflects the examination result of the component and the current time in the running history information management table 115.

Through the above-mentioned processing, it is possible to detect whether or not an abnormality is found in the current physical server 123.

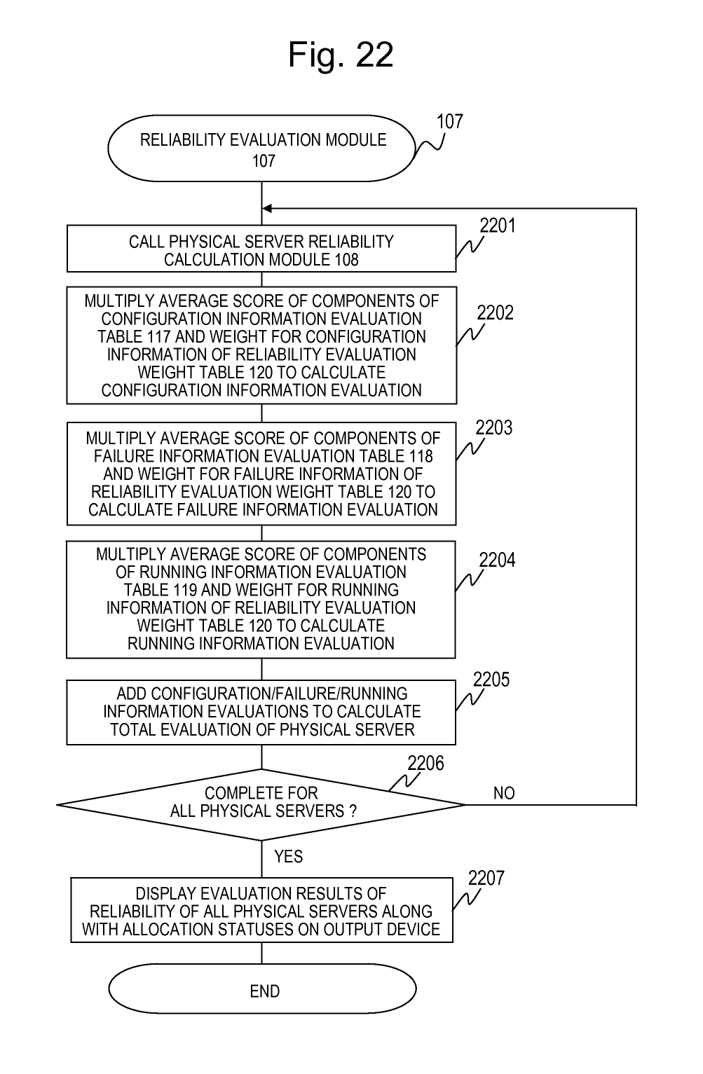

FIG. 22 is a flowchart of processing performed by the reliability evaluation module 107. This processing is executed, for example, when the administrator or the like inputs a command to display the reliability with the input device 207 of the management server 101. The reliability evaluation module 107 controls the physical server reliability calculation module 108 to express the reliability of the physical server as a score, and outputs the reliability to the output device 208.

In Step 2201, the reliability evaluation module 107 calls the physical server reliability calculation module 108 to generate the configuration information evaluation table 117. In Step 2202, based on the configuration information evaluation table 117 generated by the physical server reliability calculation module 108 and the reliability evaluation weight table 120, the reliability evaluation module 107 calculates the configuration information evaluation of the physical server 123. In this embodiment, the reliability evaluation module 107 multiplies an average score of the configuration information evaluations of the components and the weight 1502 for the configuration information of the reliability evaluation weight table 120.

In Step 2203, based on the failure information evaluation table 118 generated by the physical server reliability calculation module 108 and the reliability evaluation weight table 120, the reliability evaluation module 107 calculates the failure information evaluation of the physical server 123. In this embodiment, the reliability evaluation module 107 multiplies the average score of the components and the weight 1502 for the failure information of the reliability evaluation weight table 120.

In Step 2204, based on the running information evaluation table 119 generated by the physical server reliability calculation module 108 and the reliability evaluation weight table 120, the reliability evaluation module 107 calculates the running information evaluation of the physical server 123. In this embodiment, the reliability evaluation module 107 multiplies the average score of the components and the weight 1502 for the running information of the reliability evaluation weight table 120.

In Step 2205, based on the configuration information evaluation, the failure information evaluation, and the running information evaluation, which have been calculated as described above, the reliability evaluation module 107 calculates the total evaluation of the physical server 123 by the above-mentioned expression (6). In this embodiment, the reliability evaluation module 107 calculates the sum obtained by adding the configuration information evaluation, the failure information evaluation, and the running information evaluation as the total evaluation. It should be noted that the total evaluation may be calculated by using indices other than the configuration information evaluation, the failure information evaluation, and the running information evaluation. For example, in terms of hardware, there may be employed a method of adding, based on a bath-tub curve, which is a common index of the elapsed time since the introduction of the physical server 123 and the number of times a hardware failure has occurred, points to the physical server 123 at the elapsed time of low possibility of occurrence of the failure. Further, in terms of software, there may be employed a method of adding the number of patches applied to the software installed in the physical server 123 and importance of the patches.

In Step 2206, the reliability evaluation module 107 determines whether or not the reliability evaluation is complete for all the physical servers 123. When the reliability evaluation is not complete for all the physical servers 123, the reliability evaluation module 107 returns to Step 2201 to proceed to the reliability evaluation of the next physical server 123. When the calculation of the indices of the reliability is complete for all the physical servers 123, the reliability evaluation module 107 displays the reliability evaluation results of all the physical servers on the output device 208 along with the allocation statuses in Step 2207.

In Step 2207, the reliability evaluation module 107 refers to the configuration information evaluation table 117, the failure information evaluation table 118, and the running information evaluation table 119 to determine the configuration information evaluation, the failure information evaluation, and the running information evaluation by the above-mentioned expressions (3) to (5). Then, the reliability evaluation module 107 refers to the reliability evaluation weight table 120 to calculate the total evaluation by the above-mentioned expression (6) and display the evaluations of the physical servers 123 on the output device 208 as illustrated in FIG. 16.

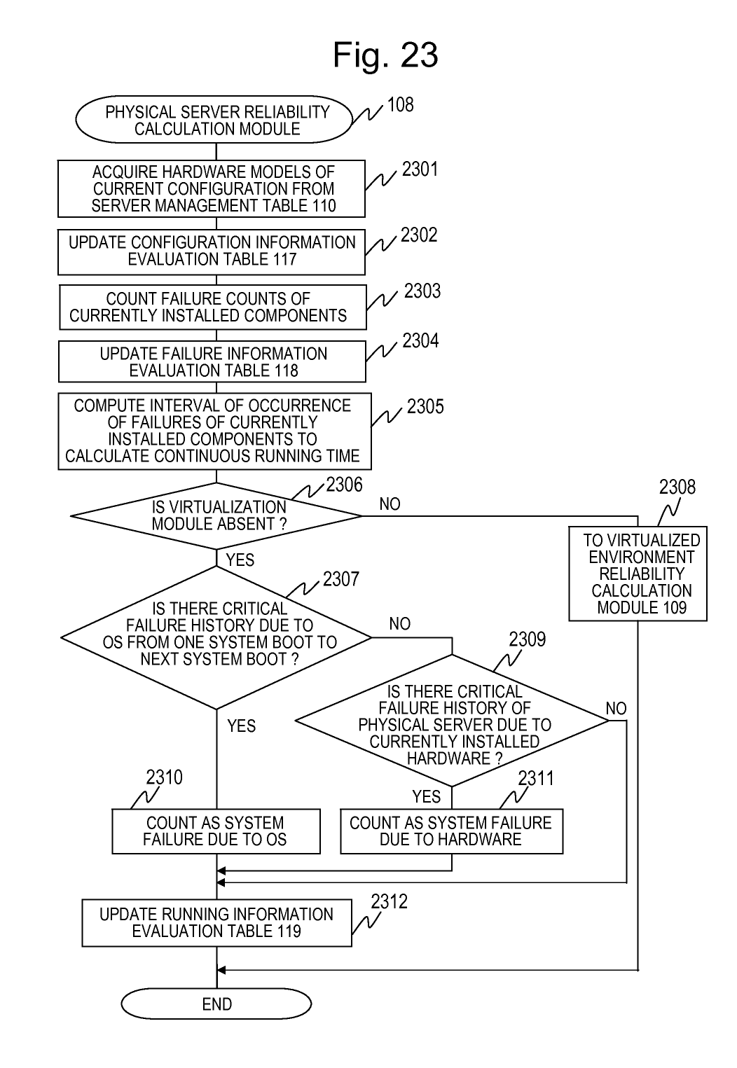

FIG. 23 is a flowchart of processing performed by the physical server reliability calculation module 108. This processing is the processing performed in Step 2201 of FIG. 22. The physical server reliability calculation module 108 evaluates the reliability of the configuration information, the failure information, and the running information of the physical server 123, and stores the evaluation results in the configuration information evaluation table 117, the failure information evaluation table 118, and the running information evaluation table 119, respectively.

In Step 2301, the physical server reliability calculation module 108 acquires from the server management table 110 information on models of the hardware currently installed in the physical server 123. In Step 2302, from the information of the server management table 110 acquired in Step 2301, for the components constituting the physical server 123, the physical server reliability calculation module 108 calculates the evaluation 1202 from the above-mentioned correspondence relationship between the identifier of each component and the evaluation 1202. The physical server reliability calculation module 108 updates the configuration information evaluation table 117 with the calculated evaluation 1202 and the component.

In Step 2303, the physical server reliability calculation module 108 refers to the running history information management table 115 to count the number of times the failure has occurred for each of the components currently installed in the physical server 123. In Step 2304, the physical server reliability calculation module 108 calculates the failure information evaluation from the counted failure count for each of the components by using the above-mentioned expression (1). Then, the physical server reliability calculation module 108 updates the failure information evaluation table 118 by associating the component and the failure information evaluation with each other.

In Step 2305, the physical server reliability calculation module 108 refers to the running history information management table 115 to calculate a continuous running time from the occurrence of the last failure or the last boot for each of the components currently installed in the physical server 123. Further, when the physical server 123 is shut down (and the life cycle information is “discarded”), a period from the occurrence of the last failure or the last boot to the immediately preceding shutdown is determined as the continuous running time.

In Step 2306, the physical server reliability calculation module 108 determines whether or not the server virtualization module 122 is present in the physical server 123. When the server virtualization module 122 is present, the physical server reliability calculation module 108 calls a virtualized environment reliability calculation module 109. When the server virtualization module 122 is not present, the physical server reliability calculation module 108 proceeds to Step 2307.

In Step 2307, the physical server reliability calculation module 108 refers to the running history information management table 115 to determine whether or not there is a critical failure history due to the OS from one system boot to the next system boot of a physical server 123. When there is a critical failure history due to the OS, the physical server reliability calculation module 108 counts the failure as a system failure due to the OS for each of the components, and holds the failure so as to be reflected to the continuous running time of the OS in the running information evaluation table 119 in Step 2312.

On the other hand, when there is no critical failure history due to the OS, the physical server reliability calculation module 108 determines in Step 2309 whether or not there is a critical failure history of the physical server due to the hardware currently installed in the physical server 123. For this determination, for example, by retaining whether or not functions such as a machine check handler of the OS, which are executed when the hardware failure occurs, have been executed in the running history information, it is possible to accurately recognize the critical failure due to the hardware. When there is a critical failure history of the physical server due to the hardware, the physical server reliability calculation module 108 counts the failure as a system failure due to the hardware for each of the components and reflects the failure to the continuous running time in the running information evaluation table 119 of the hardware in Step 2312.

When the counting of the factors of the system failures is complete, the physical server reliability calculation module 108 proceeds to Step 2312. In Step 2312, the physical server reliability calculation module 108 uses the above-mentioned expression (2) to calculate the running information evaluation from the calculated continuous running time of each of the components, and updates the running information evaluation table 119 by associating the component and the running information evaluation with each other.

Through the above-mentioned processing, the evaluations 1202, 1303, and 1403 indicating the reliability of each of the components are set in the configuration information evaluation table 117, the failure information evaluation table 118, and the running information evaluation table 119, respectively.

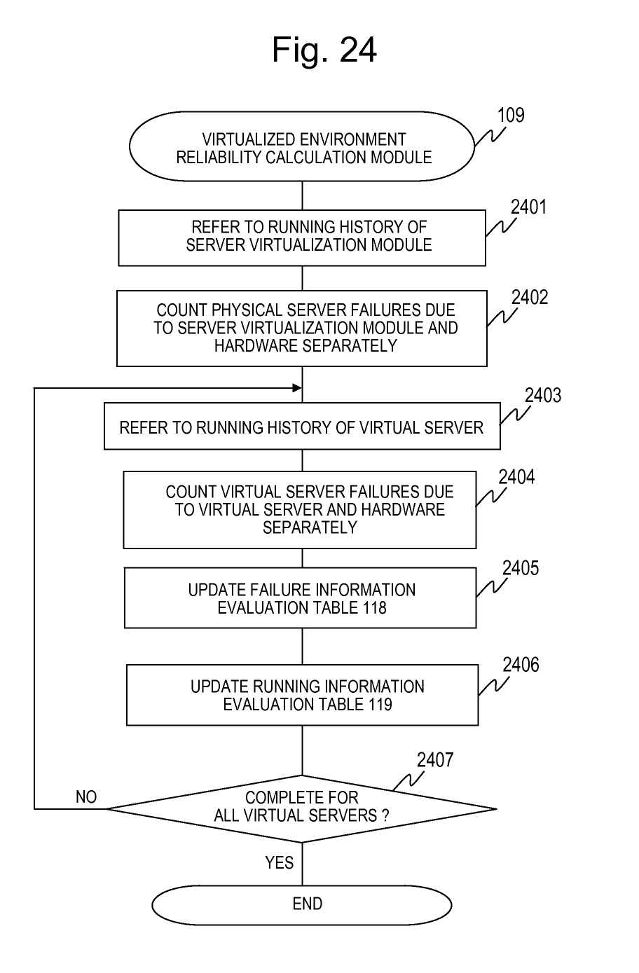

FIG. 24 is a flowchart of processing performed by the virtualized environment reliability calculation module 109. This processing is the processing performed in Step 2308 of FIG. 23. The virtualized environment reliability calculation module 109 calculates the reliability of the server virtualization module 122 and the virtual servers 121 of the physical server 123 including the server virtualization module 122.

In Step 2401, the virtualized environment reliability calculation module 109 refers to the running history information management table 115 to acquire a running history of the server virtualization module 122.

In Step 2402, the virtualized environment reliability calculation module 109 counts occurrence of the failure due to the server virtualization module 122 and occurrence of the failure due to the hardware of the physical server 123 separately for each of the components, and holds the result so as to be reflected in the running information evaluation table 119.

In Step 2403, the virtualized environment reliability calculation module 109 refers to the running history information management table 115, and selects one virtual server 121 to acquire a running history thereof. In Step 2404, the virtualized environment reliability calculation module 109 counts occurrence of the failure due to the virtual server 121 and occurrence of the failure due to the hardware of the physical server 123 separately for each of the components, and holds the result so as to be reflected in the running information evaluation table 119.

In Step 2405, the virtualized environment reliability calculation module 109 updates the failure information evaluation table 118 for each of the components for which the failures were counted in Steps 2402 and 2404 described above.

In Step 2406, the virtualized environment reliability calculation module 109 determines the evaluation result from the running histories of the virtual server 121 and the server virtualization module 122 and reflects the evaluation result in the running information evaluation table 119. In Step 2407, the virtualized environment reliability calculation module 109 determines whether the evaluation is complete for all the virtual servers 121. When the evaluation is not complete, the virtualized environment reliability calculation module 109 returns to Step 2403 to calculate the index of the reliability of the next virtual server 121.

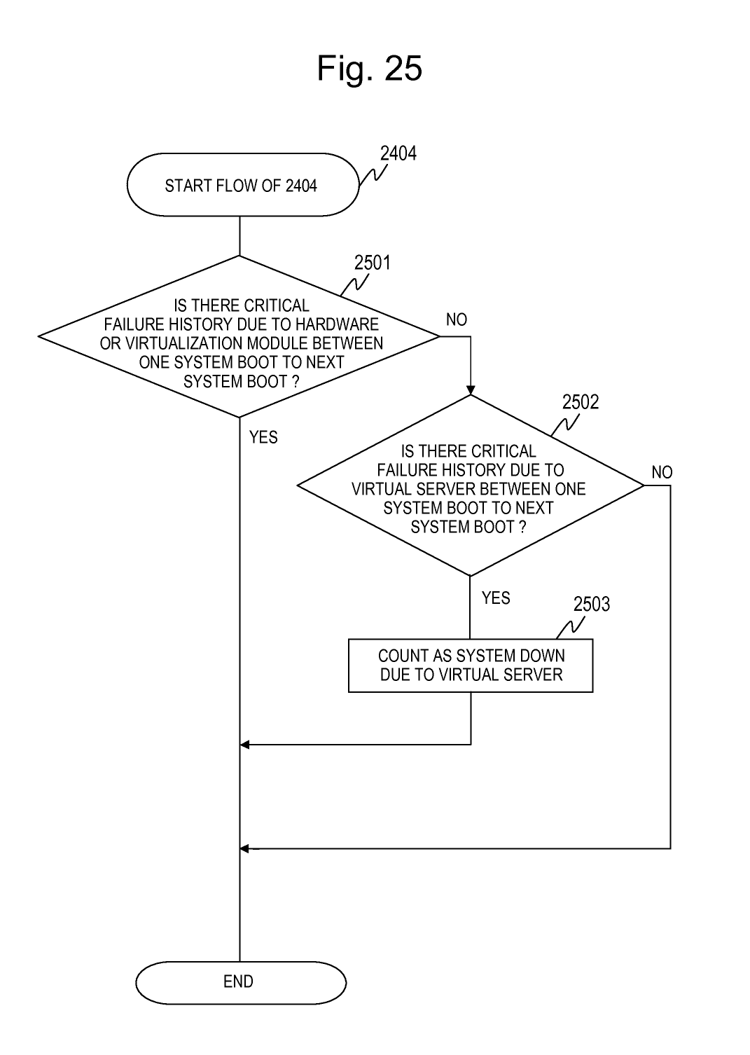

FIG. 25 illustrates in detail the processing performed in Step 2404 of FIG. 24 as a subroutine. In Step 2501, the virtualized environment reliability calculation module 109 refers to the running history information management table 115 to determine, for the virtual server 121 selected in Step 2403 of FIG. 24, whether or not there is a failure due to the hardware or the server virtualization module 122 from the last boot to the next boot. When there is a failure due to the hardware or the server virtualization module 122, the virtualized environment reliability calculation module 109 ends the subroutine to proceed to Step 2405 of FIG. 24. On the other hand, when there is no failure due to the hardware or the server virtualization module 122, the virtualized environment reliability calculation module 109 proceeds to Step 2502.

In Step 2502, for the virtual server 121 of current interest, the virtualized environment reliability calculation module 109 refers to the running history information management table 115 to determine whether or not there is a failure due to the virtual server 121 (OS 302) from the last boot to the next boot. When there is no failure due to the virtual server 121 (OS 302), the virtualized environment reliability calculation module 109 ends the subroutine to proceed to Step 2405 of FIG. 24, and when there is the failure, the virtualized environment reliability calculation module 109 proceeds to Step 2503.

In Step 2503, the virtualized environment reliability calculation module 109 counts the number of times the failure due to the virtual server 121 has occurred, and ends the subroutine.

Through the above-mentioned processing, the virtualized environment reliability calculation module 109 distinguishes the failures that have occurred in the virtual server 121 into failures due to the software and failures due to the hardware or the server virtualization module 122. Then, the virtualized environment reliability calculation module 109 counts the number of times the failure due to the virtual server 121 has occurred.

As described above, according to this invention, the management server 101 collects the configuration information, the running information, and the failure information for each of a plurality of physical servers 123, and calculates the indices of the reliability of the components, which are expressed in numerical values, from the configuration information, the running information, and the failure information of each of the physical servers 123. Then, in the reliability display screen illustrated in FIG. 16, the total evaluation 1605 indicating the reliability of each of the physical servers 123 and the allocation status 1606 of a task to the physical server 123 are output to the output device 208.

When the administrator of the management server 101 allocates a task to a physical server 123, the administrator may refer to the reliability display screen so as to consider the reliability based not only on the free resources of the physical servers 123 but also the indices of the reliability of the physical servers 123.

Further, the reliability display screen provided by the management server 101 may visualize the reliability of the physical servers 123 based on the types and the configuration information of the physical servers 123, information on the running OSs and the server virtualization modules 122, and the analysis result of the past running information. The administrator may refer to the reliability display screen to easily allocate the server having the reliability corresponding to a service level agreement (SLA) of the task to be allocated to the physical server 123.

Further, when the physical server 123 satisfies a condition to set the life cycle information to “discarded”, the management server 101 transmits the information acquisition module 330 to the physical server 123 to start the physical server 123, and then acquires pieces of information by using the information acquisition module 330. When the physical server 123 does not satisfy the condition to set the life cycle information to “discarded”, the management server 101 acquires the pieces of information by using the information acquisition module 330 that is provided in advance to run on the physical server 123. By using the life cycle information as described above, the configuration information, the failure information, and the running information of the physical server 123 may be acquired automatically without the administrator recognizing the operation status of the physical server 123.

This invention may be applied to a computer system including a plurality of physical servers and a management server for allocating tasks to the physical servers, the management server, and a program for use in the management server.

What is claimed is:

1. A computer system comprising a management server coupled to a server via a network,
the management server comprising:
a configuration information acquisition module for acquiring configuration information of the server;
a failure information acquisition module for acquiring failure information of the server;
a running information acquisition module for acquiring running information of the server; and
a reliability evaluation module for calculating an index of reliability of the server from the acquired configuration information, failure information, and running information,
the reliability evaluation module extracting components constituting the server from the configuration information, extracting failure information of each of the components from the failure information, calculating a continuous running time of the each of the components from the running information, and calculating an index of reliability of the each of the components of the server from the failure information and the continuous running time of the each of the components.

2. The computer system according to claim 1, wherein the reliability evaluation module extracts hardware components constituting the server from the configuration information, extracts failure information of each of the hardware components from the failure information, calculates a continuous running time of the each of the hardware components from the running information, and calculates indices of reliability of current hardware components and past hardware components of the server from the failure information and the continuous running time of the each of the hardware components.

3. The computer system according to claim 1, wherein the reliability evaluation module extracts software components constituting the server from the configuration information, extracts failure information of each of the software components from the failure information, calculates a continuous running time of the each of the software components from the running information, and calculates indices of reliability of current software components and past software components of the server from the failure information and the continuous running time of the each of the software components.

4. The computer system according to claim 1,
wherein the management server further comprises a life cycle information acquisition module for acquiring life cycle information indicating an operation status of the server, and
wherein, when the life cycle information satisfies a predetermined condition, the reliability evaluation module transmits an information acquisition module to the server to acquire the configuration information, the failure information, and the running information from the information acquisition module.

5. The computer system according to claim 4, wherein, when the life cycle information does not satisfy the predetermined condition, the reliability evaluation module acquires the configuration information, the failure information, and the running information from an information acquisition module provided in the server in advance.

6. A method of visualizing server reliability by expressing, by a management server coupled to a server via a network, reliability of the server as a numerical value,
the method comprising:
a first step of acquiring, by the management server, configuration information of the server;
a second step of acquiring, by the management server, failure information of the server;
a third step of acquiring, by the management server, running information of the server; and
a fourth step of calculating, by the management server, an index of reliability of the server from the acquired configuration information, failure information, and running information,
the fourth step comprising extracting components constituting the server from the configuration information, extracting failure information of each of the components from the failure information, calculating a continuous running time of the each of the components from the running information, and calculating an index of reliability of the each of the components of the server from the failure information and the continuous running time of the each of the components.

7. The method of visualizing server reliability of the server according to claim 6, wherein the fourth step comprises extracting hardware components constituting the server from the configuration information, extracting failure information of each of the hardware components from the failure information, calculating a continuous running time of the each of the hardware components from the running information, and calculating indices of reliability of current hardware components and past hardware components of the server from the failure information and the continuous running time of the each of the hardware components.

8. The method of visualizing server reliability according to claim 6, wherein the fourth step comprises extracting software components constituting the server from the configuration information, extracting failure information of each of the software components from the failure information, calculating a continuous running time of the each of the software components from the running information, and calculating indices of reliability of current software components and past software components of the server from the failure information and the continuous running time of the each of the software components.

9. The method of visualizing server reliability according to claim 6, further comprising a step of acquiring, by the management server, life cycle information indicating an operation status of the server,
wherein the fourth step comprises transmitting, when the life cycle information satisfies a predetermined condition, an information acquisition module to the server to acquire the configuration information, the failure information, and the running information from the information acquisition module.

10. The method of visualizing server reliability according to claim 9, wherein the fourth step comprises acquiring, when the life cycle information does not satisfy the predetermined condition, the configuration information, the failure information, and the running information from an information acquisition module provided in the server in advance.

11. A management server coupled to a server via a network, the management server comprising:
a configuration information acquisition module for acquiring configuration information of the server;
a failure information acquisition module for acquiring failure information of the server;
a running information acquisition module for acquiring running information of the server; and
a reliability evaluation module for calculating an index of reliability of the server from the acquired configuration information, failure information, and running information,
the reliability evaluation module extracting components constituting the server from the configuration information, extracting failure information of each of the components from the failure information, calculating a continuous running time of the each of the components from the running information, and calculating an index of reliability of the each of the components of the server from the failure information and the continuous running time of the each of the components.

12. The management server according to claim 11, wherein the reliability evaluation module extracts hardware components constituting the server from the configuration information, extracts failure information of each of the hardware components from the failure information, calculates a continuous running time of the each of the hardware components from the running information, and calculates indices of reliability of current hardware components and past hardware components of the server from the failure information and the continuous running time of the each of the hardware components.

13. The management server according to claim 11, wherein the reliability evaluation module extracts software components constituting the server from the configuration information, extracts failure information of each of the software components from the failure information, calculates a continuous running time of the each of the software components from the running information, and calculates indices of reliability of current software components and past software components of the server from the failure information and the continuous running time of the each of the software components.

14. The management server according to claim 11, further comprising a life cycle information acquisition module for acquiring life cycle information indicating an operation status of the server,
wherein, when the life cycle information satisfies a predetermined condition, the reliability evaluation module transmits an information acquisition module to the server to acquire the configuration information, the failure information, and the running information from the information acquisition module.

15. The management server according to claim 14, wherein, when the life cycle information does not satisfy the predetermined condition, the reliability evaluation module acquires the configuration information, the failure information, and the running information from an information acquisition module provided in the server in advance.
